(19) United States
(12) Patent Application Publication
(10) Pub. No.: US 2025/0010582 A1
(43) Pub. Date: Jan. 9, 2025

(54) LAMINATED PANE WITH AN EMBEDDED FUNCTIONAL FILM

(71) Applicant: SAINT-GOBAIN GLASS FRANCE, Courbevoie (FR)

(72) Inventors: Stephan GIER, Herzogenrath (DE); Marcel KLEIN, Herzogenrath (DE); Uwe VAN DER MEULEN, Herzogenrath (DE); Nino TINGS, Herzogenrath (DE)

(21) Appl. No.: 18/711,602

(22) PCT Filed: Dec. 7, 2022
(86) PCT No.: PCT/EP2022/084772

§ 371 Date: May 19, 2024

(30) Foreign Application Priority Data
Jan. 24, 2022 (EP) 22152970.4

(51) Int. Cl. B32B 17/10

(52) U.S. Cl. CPC B32B 17/10036; B32B 17/1022; B32B 17/1077; B32B 17/10779; B32B 17/10788; B32B 17/10935; B32B 2250/04; B32B 2307/202; B32B 2307/41; B32B 2307/412; B32B 2310/0806; B32B 2311/08; B32B 2419/00; B32B 2605/00

(57) ABSTRACT

A laminated pane having an outer pane and an inner pane, which are connected to one another via a thermoplastic intermediate layer. The laminated pane has an opaque masking region and a transparent see-through region. The intermediate layer has a functional film with at least one layer based on polyethylene terephthalate arranged at least partially in the masking region, an outer thermoplastic layer through which the functional film is connected to the outer pane, and a transparent inner thermoplastic layer through which the functional film is connected to the inner pane. The outer thermoplastic layer has at least one first outer connecting layer composed of at least one transparent connecting film and at least one opaque connecting film. The transparent connecting film is arranged in the viewing region and the opaque connecting film forms at least part of the masking region.

The invention relates to a laminated pane with a functional film embedded therein, a method for the production thereof, and the use thereof.

Laminated panes are in use in particular in the vehicle sector as so-called laminated safety glass, in particular as windshields, but increasingly also as roof panes, side panes or rear panes. A laminated pane comprises an outer pane and an inner pane which are connected to one another via a thermoplastic intermediate layer. The intermediate layer is typically formed from at least one connecting film, usually a PVB film.

It is known to provide laminated panes with functional films to give them additional advantageous properties. The functional films are typically formed on the basis of PET or contain at least layers of PET. Since PET itself has no adhesive effect on the glass panes, it is inserted between two connecting films of the intermediate layer in order to embed the functional film in the laminated pane. For example, functional films are common which comprise a PET carrier film and an electrically conductive coating applied thereto, typically containing at least one silver layer. Such functional films provide the laminated pane with an IR-reflective effect so that the heat input into the vehicle is reduced. Alternatively, they can also serve as reflection surfaces, for example for reflecting the radiation from a projector directed to them, whereby display images for the driver can be realised. Laminated panes with PET-based functional films are known, for example, from U.S. Pat. No. 6,280,847B1, DE19534420A1, and WO0160604A1. Alternatively, purely dielectric functional films which comprise a plurality of polymeric layers are also available, wherein layers having a higher and lower refractive index are arranged in an alternating manner. In that case too, at least some of the layers are usually formed on the basis of PET. Reflective properties as a result of interference effects can be achieved also with such a functional film, for example with respect to IR radiation or visible radiation from a projector. A laminated pane with such a functional film is known, for example, from WO03099553A1.

One problem of using such PET-based functional films results from the fact that they have a different shrinkage behaviour than typical connecting films, for example PVB films. This can lead to a so-called orange skin effect, namely distortions resulting from a deformation at the interface between the functional film and the adjacent connecting films and cause optical distortions which are visible in particular in reflection and have a disruptive effect.

Laminated panes used in the vehicle sector often have a circumferential peripheral masking region which is opaque and surrounds a transparent central viewing region. The opaque masking region serves primarily to protect the adhesive used for bonding the laminated pane to the vehicle body from UV radiation. Moreover, if the laminated pane is equipped with electrical functions (for example a heating function), the electrical connections required for this can be concealed in the masking region. The masking region is typically formed by a black cover print on the surface of the outer pane facing the intermediate layer. It has been found that the orange skin effect in this masking region is particularly noticeable, probably due to the higher contrast against the opaque background.

DE202019103729U1 discloses a laminated pane in which a masking region is formed by an opaque layer of the intermediate layer.

US 2020254731A1 discloses a laminated pane in which a masking region is formed by an opaque region of the intermediate layer. For this purpose, an opaque film portion is inserted into a cutout of the transparent intermediate layer. Avoiding a black cover print is supposed to, in particular, avoid optical distortions close to the masking region which, due to the different thermal absorption behaviour of the masking region and viewing region, can arise, for example, during a glass bending process. In certain implementations, the intermediate layer is multi-layered and comprises a PET-based functional film between two PVB-based connecting layers, wherein it is not disclosed which elements of the multi-layered intermediate layer in the masking region are replaced by the opaque film portion.

US2020290319A1 discloses a laminated pane in which a masking region is formed by additionally inserting a thin opaque polymer film into the intermediate layer. Here too, the intermediate layer is multi-layered in certain implementations and comprises a PET-based functional film between two PVB-based connecting layers.

The object of the present invention is to provide a laminated pane with a PET-based functional film, wherein said orange skin effect is less annoying. Moreover, an advantageous method for producing such a laminated pane is provided.

The object of the present invention is achieved according to the invention by a laminated pane according to claim 1. Preferred embodiments are apparent from the dependent claims.

The laminated pane according to the invention comprises an outer pane and an inner pane which are connected to one another via a thermoplastic intermediate layer. The laminated pane is provided for separating the interior space from the external environment during a window opening (in particular a window opening of a vehicle, but alternatively also a window opening of a building or a room). In the context of the invention, inner pane means the pane of the laminated pane facing the interior. Outer pane means the pane facing the external environment. The laminated pane is preferably a vehicle pane, for example a window pane of a motor vehicle, rail vehicle, ship or aircraft. Particularly preferably, the laminated pane is the windshield, side pane, rear pane or roof pane of a passenger vehicle or truck, very particularly preferably the windshield.

The outer pane and the inner pane each have an outer and an interior-side surface (main surface) and a circumferential side edge surface extending between them. In the context of the invention, the outer surface means the main surface which is provided to face the external environment when installed. In the context of the invention, the interior-side surface means the main surface which is intended to face the interior space when installed. The interior-side surface of the outer pane and the outer surface of the inner pane face one another and are connected to one another by the thermoplastic intermediate layer.

The laminated pane according to the invention has an opaque masking region and a transparent see-through region. Within the context of the invention, a masking region refers to a region of the laminated pane through which it is not possible to see. The degree of light transmission of the masking region is preferably substantially 0%. Within the context of the invention, a viewing region refers to a region of the laminated pane that allows for looking through the glass pane and therefore has a certain degree of transparency or at least translucency. The degree of light transmission of the viewing region is preferably at least 10%, particularly preferably at least 20%, very particularly preferably at least 50%. The degree of light transmission is very particularly preferably at least 70%, in particular when the laminated pane is used as a windshield of a vehicle for which a degree of total transmission must be greater than 70% (determined by the method defined by ECE-R 43, Annex 3, Sec. 9.1 for testing the light transmittance of motor vehicle panes).

In a typical embodiment, the masking region surrounds the see-through region in a frame-like manner. The masking region is thus arranged circumferentially around the see-through region. Typically, the masking region forms the edge region of the laminated pane, at least in regions in this case. This means that the masking region is adjacent at least to a portion of the side edge of the laminated pane. Often, the overall masking region forms the circumferential edge region of the laminated pane.

According to the invention, the intermediate layer has a multi-layered structure. It comprises a functional film with at least one layer based on polyethylene terephthalate (PET). The functional film is arranged between an outer thermoplastic layer or layer sequence and an inner thermoplastic layer or layer sequence. It itself typically does not have any adhesive properties relative to the outer pane and inner pane. The connection of the panes to the laminated pane is ensured by said thermoplastic layers or layer sequences which have adhesive properties relative to the outer pane and inner pane. The functional film is connected to the outer pane via the outer thermoplastic layer or layer sequence, and to the inner pane via the inner thermoplastic layer or layer sequence.

According to the invention, the functional film is arranged at least partially in the masking region of the laminated pane. It can be arranged in the masking region completely or only partially. In the latter case, the functional film has at least one region which is arranged in the masking region, and at least one further region which is arranged in the viewing region. The functional film can cover the viewing region completely or can cover only a part of the viewing region.

According to the invention, the inner thermoplastic layer or layer sequence is transparent. It preferably has a single inner connecting layer, but can also comprise several inner connecting layers arranged flat on one another. Each inner connecting layer (or the individual inner connecting layer) is preferably formed by a single transparent thermoplastic connecting film. A polymeric coating instead of a film can also be used on the inner pane and/or functional film, in particular if the relevant thermoplastic layer is to be designed to be very thin.

According to the invention, the outer thermoplastic layer or layer sequence has at least one first outer connecting layer. The first outer connecting layer has a transparent region and an opaque region. For this purpose, it is composed of two different connecting films, namely a transparent connecting film and an opaque connecting film. The opaque connecting film contains colourants (pigments or dyes) in a concentration sufficient for opacity. The transparent connecting film and the opaque connecting film are arranged side by side (relative to the viewing direction through the laminated pane) so that they are arranged in a plane of the laminated pane, wherein the opaque connecting film is arranged in said opaque region to form the latter, and the transparent connecting film is arranged in said transparent region to form the latter. The first outer connecting layer has, in particular, only the opaque connecting film and no transparent connecting film in the opaque region. In other words, the opaque region of the first outer connecting layer is formed exclusively by the opaque connecting film, and the transparent region of the first outer connecting layer is formed exclusively by the transparent connecting film. The two films are in particular assembled flush at their side edges so as to be arranged in one plane and to jointly form one layer (namely the first outer connecting layer). The transparent connecting film forms the transparent region of the first outer connecting layer and is arranged in the viewing region of the laminated pane. The opaque connecting film forms the opaque region of the first outer connecting layer and also at least part of the masking region of the laminated pane. This means that the opaque connecting film of the first outer connecting layer is the opaque element that results in a region of the laminated pane (namely the masking region or at least part of the masking region) for its part being opaque and not allowing transparency. The opaque connecting film is thus arranged in the masking region of the laminated pane and prevents the view through (or at least a part thereof) the masking region so that it becomes the opaque masking region.

In other words, the first outer connecting layer comprises a transparent viewing region which is formed by at least one transparent connecting film, and an opaque masking region which is formed by at least one opaque connecting film. The masking region of the laminated pane is at least partially formed by the opaque masking region of the first outer connecting layer.

Said first connecting layer can be the only thermoplastic layer with an opaque region. However, it is also possible to use several thermoplastic layers with opaque regions that are either in direct contact with one another or are separated from one another by at least one transparent connecting film even though this is not preferred, because it makes the structure and production of the laminated pane more complex. The opaque regions of different layers can be arranged in alignment so as to jointly form a masking region, or they can be arranged offset from one another so as to form a different masking region (more precisely: a different portion of the masking region) in each case.

In the context of the invention, an opaque film is understood to mean a film with a light transmission in the visible spectral range of less than 5%, in particular of 0%. A transparent film is understood to mean a film with a light transmission of more than 10%, preferably more than 50%, particularly preferably more than 80%.

It is possible for the opaque connecting film of the first outer connecting layer to form the entire masking region of the laminated pane. However, it is also possible for only part of the masking region to be formed by the opaque connecting film of the first outer connecting layer, while the remaining part of the masking region is formed by another opaque element, in particular a cover print (preferably on the interior-side surface of the outer pane). In that case, the functional film is preferably not arranged in that part of the masking region which is formed by the cover print, but only in that part of the masking region which is formed by the opaque connecting film of the first outer connecting layer, and optionally in the viewing region. This may be the case, for example, if the functional film overlaps only with a section of the circumferential peripheral masking region, for example along the lower edge of the laminated pane. In that case, the masking region along the lower edge can be formed, for example, by the opaque connecting film, and the masking region along the upper edge and the side edges can be formed by a conventional cover print.

In conventional laminated panes, the opaque masking region is formed by an opaque, typically black cover print that is generally applied at least on the interior-side surface of the outer pane. This cover print typically consists of an enamel, which contains glass frits and colourants (in particular pigments) and is applied by screen printing and subsequently burned. In contrast thereto, the masking region of the laminated pane according to the invention is formed by an opaque connecting film which forms a region of the first outer connecting layer. The inventors have surprisingly found that the orange skin effect produced by the functional film is less noticeable against the background of the opaque connecting film than against the background of an opaque cover print. The appearance of the laminated pane is thereby significantly improved because the orange skin effect is less noticeable to an observer. This is the major advantage of the present invention. The inventors assume that the roughness of common cover prints enhances the orange skin effect or its prominence, which can be avoided by replacing them with an opaque connecting film.

The basic idea of the invention is to replace the conventional cover print in the entire masking region or in at least part of the masking region with the opaque connecting film of the first outer connecting layer. If the entire masking region is formed by the opaque connecting film, the laminated pane therefore preferably does not have a cover print on the outer pane or the inner pane. If only part of the masking region is formed by the opaque connecting film, the remaining part of the masking region is preferably formed by a cover print which is preferably arranged at least on the interior-side surface of the outer pane, and optionally also on the interior-side surface of the inner pane. Of course, it is possible for the opaque connecting film and the cover print to overlap in one part of the masking region, in particular there where the part of the masking region formed by the cover print and the part of the masking region formed by the opaque connecting film adjoin one another. However, the cover print does not completely overlap the opaque connecting film, so that at least part of the masking region is formed solely by the opaque connecting film, and there is no cover print in that part, i.e. the outer pane and the inner pane are not provided with an opaque cover print. Such cover prints are common in particular in the vehicle sector. The cover print typically contains a pigment and glass frits. The glass frits can be melted and the cover print can thereby be permanently bonded (fused) to the glass surface. The pigment provides the opacity of the masking region. The cover print is preferably printed onto the outer pane, in particular by screen printing. The pigment is typically a black pigment, such as pigment carbon black, aniline black, bone black, iron oxide black, spinel black and/or graphite. The cover print preferably has a thickness of 5 μm to 50 μm, particularly preferably of 8 μm to 25 μm.

The outer and the inner thermoplastic layer sequences preferably each have a thickness in the range of 0.005 mm to 1.6 mm. The outer and the inner thermoplastic layers or layer sequences can have the same thickness, which is then preferably in the range of 0.3 mm to 1.0 mm, for example of 0.3 mm to 0.6 mm or of 0.7 mm to 1.0 mm.

In an advantageous configuration, the outer thermoplastic layer or layer sequence is designed to be thicker than the inner thermoplastic layer or layer sequence. This has the advantage that the reflection optics of the laminated pane, and thus its appearance, is further improved. The PET-based functional film is bonded very firmly to the inner pane due to the thin inner thermoplastic layer or layer sequence, as a result of which it can shrink less strongly, which leads to a less strongly pronounced orange skin effect. In particular, if the laminated pane is part of a projection arrangement and is irradiated by an imaging unit (for example a projector) via the inner pane, it is also advantageous for the quality of the display image if the inner thermoplastic layer or layer sequence is thin. The inner thermoplastic layer or layer sequence preferably has thicknesses of 0.005 mm to 0.55 mm, particularly preferably of 0.03 mm to 0.5 mm, very particularly preferably of 0.035 mm to 0.4 mm. It is preferably formed by a single transparent connecting film. The outer thermoplastic layer or layer sequence preferably has thicknesses of 0.3 mm to 2 mm, particularly preferably of 0.6 mm to 1.6 mm, very particularly preferably of 0.7 mm to 1.0 mm. The thicker outer thermoplastic layer or layer sequence improves the stability of the laminated pane and the shielding from annoying noises.

The outer and the inner thermoplastic layers or layer sequences are preferably formed on the basis of polyvinyl butyral (PVB), ethylene vinyl acetate (EVA) or polyurethane (PU), particularly preferably on the basis of PVB. This means that the film predominantly contains said material (more than 50% by weight) and can, in addition, optionally contain further components, for example plasticisers, stabilisers, UV- or IR-absorbers. The individual layers of the thermoplastic layers or layer sequences are preferably formed by films (connecting films) of the corresponding materials. Each film forms a thermoplastic layer with the exception of the first outer thermoplastic layer, which is composed of two different films (a transparent and an opaque connecting film). The thickness of each thermoplastic film is preferably 0.03 mm to 1 mm. For example, films, in particular PVB films, with standard thicknesses of 0.38 mm or 0.76 mm can be used. Polymeric coatings can also be used instead of films, in particular if the relevant thermoplastic layer is to be made very thin.

In a preferred configuration, the outer thermoplastic layer sequence comprises at least one further outer connecting layer in addition to the first outer connecting layer, in particular exactly one further outer connecting layer which is referred to as the second outer connecting layer. The second outer connecting layer is preferably transparent. It is preferably formed by a single transparent thermoplastic connecting film, alternatively by a thin polymeric coating. The first outer connecting layer and the second outer connecting layer are arranged flat one above the other to form the thermoplastic layer sequence. The second outer connecting layer is arranged closer to the functional film than the first outer connecting layer, and thus has a smaller distance from the functional film than the first outer connecting layer. The layers are thus arranged in the following order: outer pane-first outer connecting layer-second outer connecting layer-functional film. The first and the second outer connecting layers are preferably in direct contact with one another. The outer thermoplastic layer sequence preferably does not comprise any more layers other than the first and the second outer connecting layers so that the first outer connecting layer is in direct contact with the outer pane, and the second outer connecting layer is in direct contact with the functional film. In a particularly preferred configuration, the laminated pane consists only of the following layers in the indicated order: outer pane-first outer connecting layer-second outer connecting layer-functional film-inner connecting layer-inner pane. This configuration has, in particular, production-related advantages: the second outer connecting layer, functional film, and the inner connecting layer which are each designed in one piece, can be connected to form an easy-to-handle multi-layer film which is inserted between the panes during production of the laminated pane, as a result of which the three layers are positioned simultaneously. The thickness of the first outer connecting layer, the second outer connecting layer and the inner connecting layer is each preferably 0.005 mm to 0.55 mm, particularly preferably 0.03 mm to 0.5 mm, very particularly preferably 0.035 mm to 0.4 mm. In principle, it is also possible for the outer and/or the inner thermoplastic layer sequence to comprise further connecting layers, in particular further transparent connecting layers. In the outer thermoplastic layer sequence, these further connecting layers can be arranged between the outer pane and the first outer connecting layer, between the first outer connecting layer and the functional film.

In a further configuration, the outer thermoplastic layer sequence comprises also at least one further outer connecting layer in addition to the first outer connecting layer, in particular exactly one further outer connecting layer referred to as the second outer connecting layer. The second outer connecting layer is preferably transparent. It is preferably formed by a single transparent thermoplastic connecting film, alternatively by a thin polymeric coating. The first outer connecting layer and the second outer connecting layer are arranged flat one above the other to form the thermoplastic layer sequence. The first outer connecting layer is arranged closer to the functional film than the second outer connecting layer, thus has a smaller distance from the functional film than the second outer connecting layer. The layers are thus arranged in the following order: outer pane-second outer connecting layer-first outer connecting layer-functional film. The first and the second outer connecting layers are preferably in direct contact with one another. The outer thermoplastic layer sequence preferably does not comprise any further layers other than the first and the second outer connecting layers, so that the first outer connecting layer is in direct contact with the functional film, and the second outer connecting layer is in direct contact with the outer pane. In a particularly preferred configuration, the laminated pane consists only of the following layers in the order stated: outer pane-second outer connecting layer-first outer connecting layer-functional film-inner connecting layer-inner pane. The thickness of the first outer connecting layer, the second outer connecting layer and the inner connecting layer is each preferably 0.005 mm to 0.55 mm, particularly preferably 0.03 mm to 0.5 mm, very particularly preferably 0.035 mm to 0.4 mm. In this configuration, the functional film and the inner connecting layer, which are each designed in one piece, can be connected to form an easy-to-handle multi-layer film which is inserted between the panes during production of the laminated pane, as a result of which the two layers are positioned simultaneously. In principle, it is also possible for the outer and/or the inner thermoplastic layer sequence to comprise further connecting layers, in particular further transparent connecting layers. In the outer thermoplastic layer sequence, these further connecting layers can be arranged between the outer pane and the first outer connecting layer.

In a further configuration, there is only one single outer thermoplastic layer, namely the first outer connecting layer. The functional film is connected to the outer pane only via the first outer connecting layer. There are no further layers between the functional film and the outer pane, in particular no transparent connecting layers. The layers are thus arranged in the following order: outer pane-first outer connecting layer-functional film. The first outer connecting layer is in direct contact with the outer pane and the functional film. In a particularly preferred configuration, the laminated pane consists only of the following layers in the order stated: outer pane-first outer connecting layer-functional film-inner connecting layer-inner pane. The thickness of the first outer connecting layer is preferably 0.3 mm to 2 mm, particularly preferably 0.6 mm to 1.6 mm, very particularly preferably 0.7 mm to 1.0 mm. The thickness of the inner connecting layer is preferably 0.005 mm to 0.55 mm, particularly preferably 0.03 mm to 0.5 mm, very particularly preferably 0.035 mm to 0.4 mm. In this configuration too, the functional film and the inner connecting layer, which are each designed in one piece, can be connected to form an easy-to-handle multi-layer film which is inserted between the panes during production of the laminated pane, as a result of which the two layers are positioned simultaneously. In principle, it is also possible for the inner thermoplastic layer sequence to comprise further connecting layers, in particular further transparent connecting layers.

The functional film has at least one layer based on or made of PET. The amount of PET in said layer is preferably more than 90 wt %, particularly preferably more than 95 wt %. Preferably, said layer consists substantially of PET. In the context of the present invention, the functional film can also be referred to as PET-based or PET-containing. It is provided and suitable for equipping the laminated pane or a region of the laminated pane with an additional function. In a preferred configuration, said function is a reflective function with respect to electromagnetic radiation, in particular in the infrared and/or visible spectral range. The functional film is therefore preferably a film reflecting IR and/or visible light. The functional film preferably has a thickness of 20 μm to 200 μm, particularly preferably of 25 μm to 75 μm.

In a first advantageous configuration, the functional film comprises a carrier film based on or made of PET and an electrically conductive coating applied thereto. The electrically conductive coating comprises at least one layer based on a metal, in particular silver. Such a coating has IR-reflective properties. It can be used as a sun protection coating in order to reduce the passage of infrared portions of the solar radiation through the laminated pane. Warming of the interior behind the laminated pane can thus be reduced, and thermal comfort can thus be improved. It typically also has (partially) reflective properties in the visible range so that the functional film can serve as a reflection surface for a display system when irradiated by an imaging unit (for example a projector). The coating is preferably designed to be transparent, in particular if the functional film is also arranged in the viewing region of the laminated pane. Light transmittance of the viewing region is then not reduced to a critical extent by the conductive coating. Typically, only thin metallic layers (having a thickness of, for example, up to 20 μm) and dielectric layers, which serve inter alia as an anti-reflection coating for the metallic layers, are used for transparent coatings. If the functional film is arranged exclusively in the masking region, the coating does not have to be transparent. In that case, a thicker silver layer in the manner of a mirror can also be used which, for example, serves as a reflection surface for a display system.

In a second advantageous configuration, the functional film is a purely dielectric polymeric film which contains alternating layers with different refractive indices. The film has no metal-containing coatings. It is a purely dielectric layer sequence made of polymeric layers having a higher refractive index and polymeric layers having a lower refractive index, which are arranged alternatingly. At least one of the two layer types is formed on the basis of PET. The other layer type can likewise be formed on the basis of PET, wherein the different refractive indices are achieved by means of suitable additives, on the basis of a PET copolymer or on the basis of another polymer, for example PMMA. By the alternation of layers with different refractive indices, optical interference effects are achieved, which can be suitably adjusted for the respective application (in particular by the selection of the layer thicknesses and of the refractive indices) in order to realise reflective properties within a desired spectral range. IR-reflective properties can thus also be achieved with such a film in order to reduce the passage of infrared portions of the solar radiation. Reflective properties in the visible spectral range can also be achieved in order to use the functional film as a reflection surface for a display system.

The functional film can extend up to the side edges of the laminated pane, either circumferentially so that the functional film covers the entire surface of the laminated pane and so that the connecting films adjoining the functional film on both sides have no contact with one another, or only up to a segment of the circumferential side edge, wherein the functional film covers only a segment of the laminated pane. Alternatively, however, it is also possible for the functional film to cover only a segment of the laminated pane and not to extend to the side edge of the laminated pane. The connecting films adjoining the functional film on both sides then come into contact with one another about the entire side edge of the functional element, and the functional film is completely encapsulated in the intermediate layer and has no contact with the surrounding atmosphere. The latter case is particularly advantageous if the functional film has a metal-containing coating which is thus protected from corrosion.

The outer pane and the inner pane are preferably glass panes, particularly preferably made of soda-lime glass, as is customary for window panes. However, one or both of the panes can also be manufactured from other types of glass, for example quartz glass, borosilicate glass or aluminosilicate glass, or from rigid clear plastics, for example polycarbonate or polymethyl methacrylate. The panes can be clear or tinted or coloured. The thicknesses of the outer pane and the inner pane are, independently of one another, preferably from 0.5 mm to 5 mm, particularly preferably from 1 mm to 3 mm.

In a preferred configuration, the outer surface of the outer pane does not have any coatings or prints, i.e. it is completely exposed and uncoated. The remaining surfaces of the panes can have conventional coatings, in particular transparent coatings. For example, this applies to:
(usually silver-containing) sun protection coatings on the interior-side surface of the outer pane, which reflect infrared portions of the sun radiation;
so-called low-e coatings on the interior-side surface of the inner pane, which reflect thermal radiation from the laminated pane, for example with a layer based on a transparent electrically conductive oxide (TCO) such as ITO;
anti-reflection coatings, for example on the interior-side surface of the inner pane.

The laminated pane is preferably curved in one or more spatial directions, as is common in particular for motor vehicle panes. Typical radii of curvature are in the range of approximately 10 cm to approximately 40 m. The interior-side surface of the inner pane is generally concavely curved, the outer surface of the outer pane is generally convexly curved.

The invention also comprises a projection arrangement. The projection arrangement comprises a laminated pane according to the invention and an imaging unit. The imaging unit irradiates the functional film via the inner pane with electromagnetic radiation in the visible spectral range in order to generate a display image, which a user located in the interior can see. The imaging unit is thus arranged on the interior side of the laminated pane and irradiates the laminated pane via the interior-side surface of the inner pane. The radiation from the imaging unit is (partially) reflected at the functional film. The irradiated region of the functional film can be located in the viewing region and/or in the masking region of the laminated pane. A so-called head-up display (HUD) can be realised in the viewing region which projects information into the driver's field of view without him having to take his eyes off the road. In the masking region as well, displays can also be useful or desired for aesthetic reasons. For example, displays hitherto located in the dashboard of a vehicle can now be integrated into the laminated pane. In case of a projection arrangement, the laminated pane is preferably the windshield of a vehicle.

The imaging unit can be, for example, a projector or an electronic display, for example an LCD, LED, or TFT display. A projector can be preferred; it can produce a good and high-intensity display image either in the viewing region or in the masking region. Alternatively, a display as an imaging unit can be advantageously used, in particular, for display images in the masking region.

The region of the laminated pane irradiated by the imaging unit in which the display image is generated is referred to as the display area in the context of the invention.

In a preferred configuration, the imaging unit irradiates the functional film in the masking region. The orange skin effect is annoying in particular in reflection. In a conventional masking region designed by a cover print, the orange skin effect is particularly noticeable and would lead to disruption of the display image, in particular to optical distortions. This is avoided or at least reduced by the masking region designed according to the invention so that the optical quality of the display image is improved.

In a particularly advantageous configuration, the radiation from the imaging unit has a p-polarised portion. The p-polarised radiation portion is preferably more than 50%, particularly preferably more than 70%, very particularly preferably more than 90% of the radiation from the imaging unit. In a particularly advantageous configuration, the radiation from the imaging unit is substantially purely p-polarised; the p-polarised radiation portion is thus 100% or deviates only insignificantly therefrom. The indication of the polarisation direction refers to the plane of incidence of the radiation on the laminated pane. P-polarised radiation refers to a radiation the electric field of which oscillates in the plane of incidence. P-polarised radiation refers to a radiation the electric field of which oscillates perpendicular to the plane of incidence. The plane of incidence is spanned by the incident vector and the surface normal of the laminated pane in the geometric centre of the irradiated region. The polarisation, i.e. in particular, the proportion of p- and s-polarised radiation, is determined at a point of the display area, preferably at the geometric centre of the display area. If the laminated pane is curved, which is usually the case in particular with vehicle panes, this has an effect on the plane of incidence of the radiation of the imaging unit. For this reason, polarisation components slightly deviating therefrom can occur in the other areas, which is unavoidable for physical reasons.

The radiation from the imaging unit impinges on the laminated pane preferably at an angle of incidence of 45° to 70°, in particular of 60° to 70°. In an advantageous embodiment, the angle of incidence deviates by at most 10° from the Brewster angle. The p-polarised radiation is then reflected only insignificantly at the surfaces of the laminated pane. The functional film thus constitutes the only significant reflection surface for the radiation of the imaging unit. If the radiation were to be significantly reflected also at the external surfaces of the laminated pane (air-glass transition), this would produce multiple images which would at least be annoying, if not entirely unacceptable, for the user. The angle of incidence is the angle between the vector of incidence of the radiation from the imaging unit and the interior-side surface normal (i.e. the surface normal on the interior-side external surface of the laminated pane) at the geometric centre of the display area. The Brewster angle for an air-glass transition in the case of soda-lime glass, which is generally common for window panes, is 56.5° (with a refractive index of soda lime glass at 550 nm of 1.51). Ideally, the angle of incidence should be as close as possible to this Brewster angle. However, angles of incidence of 65°, for example, can also be used, which are common for HUD projection arrangements, are easy to implement in vehicles and deviate only slightly from the Brewster angle so that the reflection of the p-polarised radiation increases only insignificantly.

The invention also comprises a method for producing a laminated pane having an opaque masking region and a transparent viewing region, wherein:
(a) an outer pane, an outer thermoplastic layer or layer sequence, a functional film having at least one layer based on polyethylene terephthalate (PET), a transparent inner thermoplastic layer or layer sequence, and an inner pane are arranged flat one above the other in the indicated order to form a layer stack, wherein the outer thermoplastic layer or layer sequence has at least one first outer connecting layer which is composed of at least one transparent connecting film and at least one opaque connecting film, wherein the opaque connecting film at least partially overlaps the functional film;
(b) the layer stack is subsequently laminated to form the laminated pane, wherein the opaque connecting film forms at least part of the opaque masking region of the laminated pane, and the transparent connecting film is arranged in the transparent viewing region of the laminated pane. An intermediate layer, which connects the outer pane and the inner pane to one another, is formed from the outer thermoplastic layer or layer sequence, the functional film, and the inner thermoplastic layer or layer sequence during lamination. Since the opaque connecting film at least partially overlaps the functional film in method step (a), the functional film is at least partially arranged in the masking region of the laminated pane.

The above embodiments and preferred configurations in connection with the laminated pane apply equally to the method.

The thermoplastic layers are preferably arranged in that a corresponding thermoplastic connecting film is positioned at the corresponding location. Alternatively, however, one or both of the adjoining layers can be also provided with a thin polymeric coating.

In an advantageous embodiment, in method step (a), a transparent inner connecting layer and the functional film are first arranged flat one above the other and connected in a permanently stable manner to form a multi-layer film (more precisely, a bilayer), for example by adhesive bonding or lamination (in particular under the influence of temperature). The advantage of the multi-layer film is that it can be handled as a single connecting film; the two layers are positioned together in the layer stack in one step and do not have to be arranged individually and congruently one after the other in the layer stack. The transparent connecting layer is in particular formed in one piece from a transparent inner connecting film so that the multi-layer stack is comparatively simple to produce.

The outer pane, optionally one or more further layers of the outer thermoplastic layer film, the first outer connecting layer, optionally one or more further layers of the outer thermoplastic layer film, the bilayer film, and the inner pane are subsequently arranged flat one above the other in the indicated order to form the layer stack, wherein the inner connecting layer of the multi-layer film is positioned facing the inner pane so that it forms the inner thermoplastic layer of the laminated pane after lamination. In principle, it is however possible for further connecting layers to be inserted between the functional film and the inner pane, in particular transparent connecting layers, which then together with said inner connecting layer form the inner thermoplastic layer sequence.

In a particularly advantageous embodiment, in method step (a), a transparent inner connecting layer, the functional film and a transparent second outer connecting layer are first arranged flat one above the other in the indicated order, and are connected in a permanently stable manner to form a multi-layer film (more precisely, a trilayer), for example by adhesive bonding or lamination (in particular under the influence of temperature). The functional film is securely embedded in the multi-layer film and, on account of the outer connecting layers, it has adhesive properties relative to the panes and other connecting layers. The advantage of the multi-layer film is that it can be handled as a single connecting film; the three layers are positioned together in the layer stack in one step and do not have to be arranged individually and congruently one after the other in the layer stack. The transparent connecting layers are in particular formed in one piece from a transparent connecting film in each case so that the multi-layer stack is rather simple to produce. A multi-layer stack involving the multi-piece first outer connecting layer would be more complex to produce.

The outer pane, the first outer connecting layer, the multi-layer film, and the inner pane are subsequently arranged flat one above the other in the indicated order to form the layer stack, wherein the inner connecting layer of the multi-layer film faces the inner pane so that it forms the inner thermoplastic layer of the laminated pane after lamination. The second outer connecting layer of the multi-layer film is positioned facing the first outer connecting layer so that it forms, together with the first outer connecting layer, the outer thermoplastic layer sequence after lamination. The produced laminated pane then consists of the following layers in the indicated order: outer pane-first outer connecting layer-second outer connecting layer-functional film-inner connecting layer-inner pane. In principle, it is however possible for further connecting layers to be inserted, in particular transparent connecting layers. If such a further transparent connecting layer is arranged between the multi-layer film and the inner pane, it forms, together with said inner connecting layer, the inner thermoplastic layer sequence (the inner connecting layer thus as part of the inner thermoplastic layer sequence). If such a further transparent connecting layer is arranged between the multi-layer film and the first outer connecting layer, or between the first outer connecting layer and the outer pane, it therefore becomes part of the outer layer sequence.

Said multi-layer films are preferably provided in large-area form, for example as rolled goods, with dimensions that are significantly larger than the area of typical laminated panes. A matching piece is then cut out during production of the laminated pane, as is also customary with simple connecting films. This is why the multi-piece first outer connecting layer should not be part of the multi-layer film where the arrangement of the opaque region depends on the respective laminated pane. Therefore, providing large-area rolls is not possible, and the multi-layer film could be produced at best from the individual layers that have already been cut to size, which generally would not result in any methodological advantages.

In method step (b), the obtained layer stack is laminated to form the laminated pane. Known methods, for example autoclave methods, vacuum bag methods, vacuum ring methods, calender methods, vacuum laminators or combinations thereof, may be used for this purpose. The connection of the panes via the intermediate layer is usually done under the influence of heat, vacuum, and/or pressure.

If the laminated pane is to be curved, the outer pane and the inner pane will be subjected to a bending process before lamination in order to bring them into a cylindrically or spherically curved shape. For bending, the panes are softened by heating so that they can become plastically pliable, and are then shaped by methods known per se, for example by gravity bending, press bending and/or suction bending. Typical temperatures for glass-bending processes are, for example, 500° C. to 700° C.

The invention further comprises the use of a laminated pane according to the invention in buildings, for example in the access or window region, or in means of transportation for traffic on land, in the air or in water, preferably as a vehicle pane, preferably as a windshield, rear pane, side pane or roof pane of a motor vehicle, in particular as a windshield of a motor vehicle.

The invention is explained in more detail with reference to a drawing and exemplary embodiments. The drawing is a schematic representation and is not true to scale. The drawing does not limit the invention in any way. In the figures:

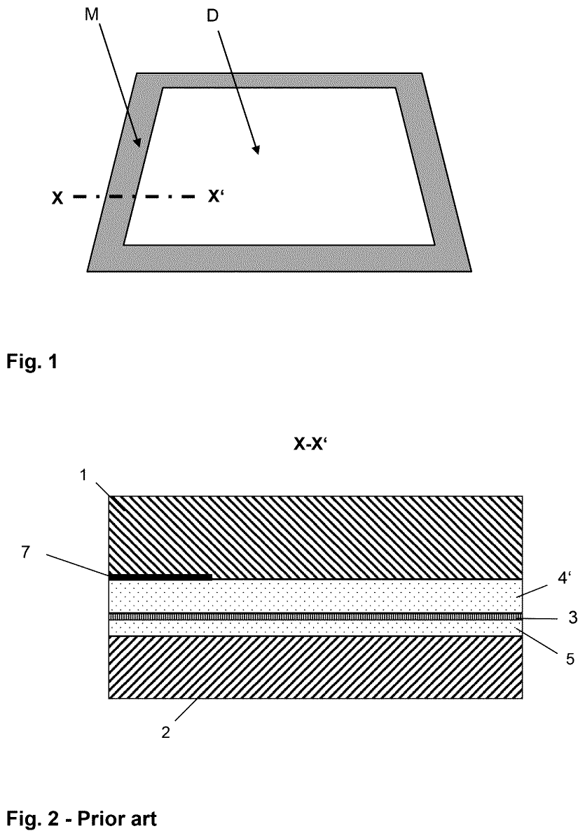

FIG. 1 shows a plan view of a generic laminated pane;

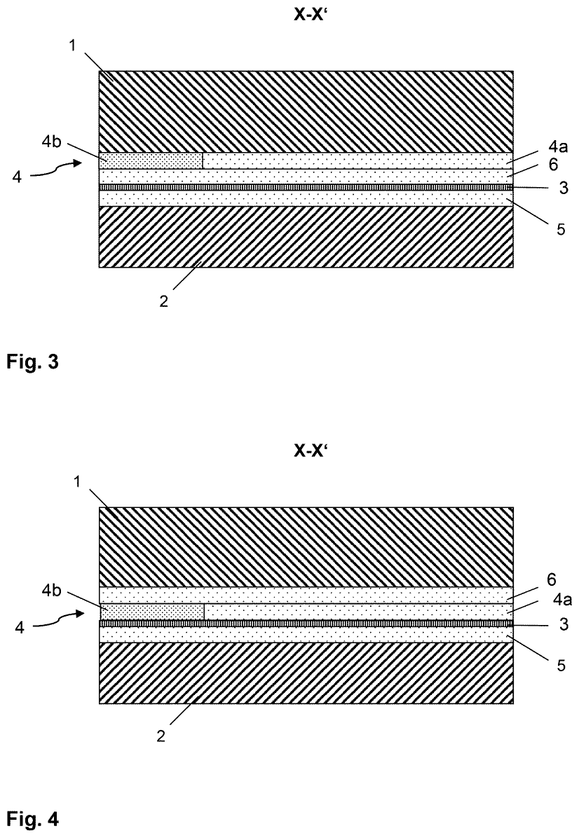

FIG. 2 shows a cross section along X-X′ through a generic laminated pane according to prior art;

FIG. 3 shows a cross section along X-X′ through a configuration according to the invention of the laminated pane;

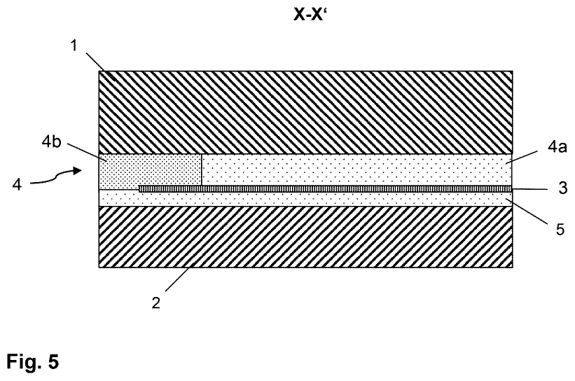

FIG. 4 shows a cross section along X-X′ through a further configuration according to the invention of the laminated pane;

FIG. 5 shows a cross section along X-X′ through a further configuration according to the invention of the laminated pane.

FIG. 1 shows a plan view of a generic laminated pane with an opaque masking region M and a transparent viewing region D. The laminated pane is, for example, the windshield of a motor vehicle. The masking region M is arranged in a circumferential edge region of the laminated pane and surrounds the viewing region D. Such masking regions are customary in vehicle panes; they serve to protect the adhesive used for bonding the laminated pane to the vehicle body from UV radiation. In addition, any electrical connections or the side edge of an embedded functional film can be hidden within the masking region M.

FIG. 2 shows a cross section along section line X-X′ of a conventional generic laminated pane. For the sake of simplicity, the laminated pane is shown flat, although vehicle panes are usually curved, which is also preferred within the scope of the present invention. The laminated pane comprises an outer pane 1 and an inner pane 2, which are connected to one another via a thermoplastic intermediate layer. The outer pane 1 and the inner pane 2 consist of soda-lime glass. The outer pane 1 has, for example, a thickness of 2.1 mm, the inner pane 2 has a thickness of 1.6 mm.

The intermediate layer has a multi-layered structure. It comprises a functional film 3 made up, for example, of a sequence of polymeric dielectric layers, wherein the layers alternatingly have a higher and a lower refractive index. At least some of the layers consist of PET. By interference, the functional film 3 has reflective properties, for example with respect to IR radiation or visible light. The functional film 3, which, for example, has a thickness of 50 μm, covers the entire laminated pane and extends circumferentially up to the side edge of the laminated pane. It can serve to reduce the transmission of infrared portions of the solar radiation and to thus improve thermal comfort in the vehicle. Additionally or alternatively, it can serve as a reflection surface for a display system, wherein it is irradiated by an imaging unit (for example a projector) arranged on the interior side and reflects this radiation back into the interior, thereby producing a display image that can be seen by the driver. This display image can be perceivable in the viewing region D (for example head-up display) or in the masking region M.

The intermediate layer further contains a transparent outer connecting layer 4′ and a transparent inner connecting layer 5. The functional film 3 is connected to the outer pane 1 via the outer connecting layer 4′ and to the inner pane 2 via the inner connecting layer 5. The connecting layers 4′, 5 are made of commercially available PVB films, which also contain plasticisers. The outer connecting layer 4′ has a thickness of 0.76 mm, the inner connecting layer 5 has a thickness of 0.38 mm.

The opaque masking region M is formed by a black cover print 7 on the interior-side surface of the outer pane facing the intermediate layer. Said cover print 7 is typically formed from a black enamel. It is imprinted as printing ink with a black pigment and glass frits in a screen printing method and is burned into the pane surface.

The PET-based functional film 3 can produce a so-called orange skin effect, which is visible in particular in reflection and results in optical distortions. It has been found that this orange skin effect is particularly noticeable against the cover print 7.

In contrast, FIG. 3 shows a cross section along section line X-X′ of a configuration of the laminated pane according to the invention. The outer pane 1, the inner pane 2, the functional film 3 and the inner connecting layer 5 are designed in the same way as in the conventional configuration of FIG. 2. However, the functional film 3 is connected to the outer pane 1 by a thermoplastic layer sequence which comprises a first outer connecting layer 4 and a second outer connecting layer 6. The second outer connecting layer 6 is formed from a transparent PVB film with a thickness of 0.38 mm. The first outer connecting layer 4 is composed of a transparent film 4a and an opaque film 4b, each based on PVB with a thickness of 0.38 mm. The opaque film 4b prevents the view through the laminated pane and thus forms the masking region M. There is no cover print as in the conventional laminated pane of FIG. 2.

The inventors have found that the orange skin effect is considerably less noticeable against the background of the opaque film 4b than against the background of the cover print 7. Optical distortions are less disturbing, which can be seen with the naked eye and can be used for a qualitative comparison (for example with a lamp reflected at the laminated pane). This is the major advantage of the present invention.

The first outer connecting layer 4 faces the outer pane 1, and the second outer connecting layer 6 faces the functional film 3. This has the advantage that the second outer connecting layer 6, the functional film 3 and the inner connecting layer 5, which are each formed in one piece, can be already connected to form a pre-laminated multi-layer film before the production of the laminated pane, which is then easier to handle than if each individual layer in the layer stack has to be arranged between the panes 1, 2. In contrast, a multi-layer film involving the multi-piece first outer connecting layer 4 would be more complicated to produce, especially since such multi-layer film are typically provided as rolled goods on a large scale, and a piece required for the respective laminated pane is then cut out.

FIG. 4 shows a cross section along section line X-X′ of a further configuration of the laminated pane according to the invention. It has the same components as the configuration of FIG. 3, which are also designed in the same way, but the two outer connecting layers 4, 6 are arranged in reverse order. The first outer connecting layer 4 faces the functional film 3, and the second outer connecting layer 6 faces the outer pane 1.

FIG. 5 shows a cross section along section line X-X′ of a further configuration of the laminated pane according to the invention. The outer pane 1, the inner pane 2 and the inner connecting layer 5 are designed in the same way as in FIGS. 3 and 4. A single outer thermoplastic layer instead of an outer thermoplastic layer sequence is present, namely the first outer connecting layer 4 having a thickness of 0.76 mm. It is, in turn, composed of a transparent film 4a in the viewing region D and an opaque film 4b in the masking region M.

In that case, the functional film 3 is a PET carrier film having a thickness of about 50 μm, on which an electrically conductive coating with silver layers is applied. Since the silver layers are susceptible to corrosion, the functional film 3 does not extend up to the side edge of the laminated pane. Instead, the inner connecting layer 5 and the first outer connecting layer 4 are fused directly to one another in the circumferential edge region of the laminated pane so that the functional film is encapsulated in the intermediate layer. Such functional films 3 are sold, for example, by Eastman under the product name XIR.

The shown configurations are to be understood merely by way of example and are not intended to limit the invention. In particular, a functional film 3 as in FIG. 5 can also be combined with the outer thermoplastic layer sequences of FIGS. 3 and 4, and a functional film 3 as in FIGS. 3 and 4 can also be combined with the individual outer thermoplastic layer of FIG. 5.

### EXAMPLE

The orange skin effect was assessed by the qualitative evaluation of the reflection of a ceiling lamp on a laminated pane. In the example according to the invention, the masking region of the laminated pane was formed by an opaque film; in the comparative example, it was formed in a conventional manner by a black cover print (burned enamel with glass frits) on the surface of the outer pane facing the intermediate layer. The inner pane was facing the ceiling lamp, and it was assessed to what extent the reflected image showed waviness as a result of the orange skin effect.

The following observations were made:
Example: The contour lines of the reflection of the ceiling lamp were even, the reflection was “smooth” overall.
Comparative example: The contours of the reflection of the ceiling lamp appeared to be clearly wavy.

The inventors attribute this observation to the fact that the orange skin effect in the comparative example is caused or intensified by the roughness of the cover print, which can be prevented by using the opaque film.

### LIST OF REFERENCE SIGNS

(1) Outer pane
(2) Inner pane
(3) Functional film based on PET
(4) First outer connecting layer
(4a) Transparent film of the first outer connecting layer 4
(4b) Opaque film of the first outer connecting layer 4
(4′) Conventional transparent outer connecting layer
(5) Inner connecting layer
(6) Second outer connecting layer
(7) Cover print
X-X′ Cross section line

1.-15. (canceled)

16. A laminated pane, comprising:
an outer pane,
an inner pane,
a thermoplastic intermediate layer through which the outer pane is connected to the inner pane,
an opaque masking region and
a transparent see-through region,
wherein the thermoplastic intermediate layer comprises:
(a) a functional film having at least one layer based on polyethylene terephthalate (PET) which is arranged at least partially in the opaque masking region,
(b) an outer thermoplastic layer comprising one or more layers in sequence through which the functional film is connected to the outer pane, and
(c) a transparent inner thermoplastic layer comprising one or more layers in sequence through which the functional film is connected to the inner pane,
wherein the outer thermoplastic layer comprises a first outer connecting layer comprising a transparent connecting film and an opaque connecting film,
wherein the transparent connecting film is arranged in the transparent see-through region and the opaque connecting film forms at least part of the opaque masking region.

17. The laminated pane according to claim 16, wherein the outer thermoplastic layer further comprises a transparent second outer connecting layer arranged flat against the first outer connecting layer, wherein the transparent second outer connecting layer is arranged closer to the functional film than the first outer connecting layer.

18. The laminated pane according to claim 16, wherein the outer thermoplastic layer further comprises a transparent second outer connecting layer arranged flat against the first outer connecting layer, wherein the first outer connecting layer is arranged closer to the functional film than the transparent second outer connecting layer.

19. The laminated pane according to claim 16, wherein the first outer connecting layer comprises a single outer thermoplastic layer.

20. The laminated pane according to claim 16, wherein the functional film is a purely dielectric polymeric film which contains alternating layers with different refractive indices.

21. The laminated pane according to claim 16, wherein the functional film is configured as a carrier film based on PET with an electrically conductive coating applied thereto, which electrically conductive coating comprises at least one layer based on a metal, in particular silver.

22. The laminated pane according to claim 21, wherein the metal is silver.

23. The laminated pane according to claim 16, wherein the outer thermoplastic layer is thicker than the transparent inner thermoplastic layer.

24. The laminated pane according to claim 16, wherein the outer thermoplastic layer and the transparent inner thermoplastic layer are formed with at least one of: polyvinyl butyral (PVB), ethylene vinyl acetate (EVA), and polyurethane (PU).

25. The laminated pane according to claim 16, wherein at least part of the opaque masking region is formed solely by the opaque connecting film, and wherein the outer pane and the inner pane are not provided with an opaque cover print in the at least part of the opaque masking region.

26. The laminated pane according to claim 25, wherein the opaque masking region is formed solely by the opaque connecting film, and wherein the outer pane and the inner pane are not provided with an opaque cover print in the opaque masking region.

27. A projection arrangement, comprising:
a laminated pane according to claim 16, and
an imaging unit which irradiates the functional film via the inner pane to produce a display image.

28. The projection arrangement according to claim 27, wherein the imaging unit irradiates the function film via the inner pane in the opaque masking region.

29. The projection arrangement according to claim 27, wherein radiation from the imaging unit is p-polarised.

30. A method for producing a laminated pane having an opaque masking region and a transparent viewing region, the method comprising the steps of:
(a) arranging flat one above the other in order, to form a layer stack, the layers of:
(i) an outer pane,
(ii) an outer thermoplastic layer comprising one or more layers in sequence,
(iii) a functional film of at least one layer based on polyethylene terephthalate (PET),
(iv) a transparent inner thermoplastic layer comprising one or more layers in sequence, and
(v) an inner pane,
(b) laminating the layer stack to form the laminated pane,
wherein the outer thermoplastic layer comprises a first outer connecting layer comprising a transparent connecting film and an opaque connecting film,
wherein the opaque connecting film at least partially overlaps the functional film and forms at least part of the opaque masking region of the laminated pane, and
wherein the transparent connecting film is arranged in the transparent viewing region of the laminated pane.

31. The method according to claim 30, further comprising the steps of:
(a1) before the arranging, connecting flat one above the other in order, to form a multi-layer film, the layers of:
a transparent inner connecting layer and
the functional film,
wherein the transparent inner connecting layer of the multi-layer film faces the inner pane such that the inner connecting layer forms at least a part of the transparent inner thermoplastic layer.

32. The method according to claim 30, further comprising the steps of:
(a2) before the arranging, connecting flat one above the other in order, to form a multi-layer film, the layers of:
a transparent inner connecting layer,
the functional film, and
a transparent second outer connecting layer,
wherein the transparent inner connecting layer of the multi-layer film faces the inner pane such that the inner connecting layer forms at least a part of the inner thermoplastic layer, and
wherein the transparent second outer connecting layer of the multi-layer film faces the first outer connecting layer such that the first outer connecting layer and the second outer connecting layer form at least a part of the outer thermoplastic layer.

33. A building comprising the laminated pane according to claim 16.

34. A vehicle comprising the laminated pane according to claim 16, the vehicle being a transport for traffic on land, in air, or in water.

35. The vehicle according to claim 34, wherein the laminated pane is a windshield of the vehicle.
